(19) United States
(12) Patent Application Publication
(10) Pub. No.: US 2014/0191985 A1
(43) Pub. Date: Jul. 10, 2014

(54) METHOD AND DEVICE FOR CONTROLLING ELECTRONIC DEVICE

(71) Applicant: Acer Incorporated, New Taipei City (TW)

(72) Inventors: Yu-Mao Feng, New Taipei City (TW); Chia-Hui Feng, New Taipei City (TW); Yu-Jing Wang, New Taipei City (TW)

(21) Appl. No.: 13/935,579

(22) Filed: Jul. 5, 2013

(30) Foreign Application Priority Data
Jan. 7, 2013 (TW) 102300150
May 31, 2013 (TW) 102119358

(51) Int. Cl. G06F 3/0488; G06F 3/0484

(52) U.S. Cl. CPC G06F 3/0488; G06F 3/04845
USPC 345/173

(57) ABSTRACT

A method and a device for controlling an electronic device having a touch screen are provided. The present method includes displaying a plurality of first type sub-images on the touch screen at an original angle when the electronic device is in a first state, where the first type sub-images constitute a first operation screen of the first state. The present method also includes detecting a sliding operation performed on the touch screen and flipping at least one of the first type sub-images according to the sliding operation. The present method further includes when the sliding operation corresponds to a specific gesture, flipping all the first type sub-images to a maximum angle to display a second operation screen of a second state of the electronic device and switching the electronic device from the first state to the second state.

### CROSS-REFERENCE TO RELATED APPLICATION

This application claims the priority benefits of Taiwan application serial no. 102300150, filed on Jan. 7, 2013, and Taiwan application serial no. 102119358, filed on May 31, 2013. The entirety of each of the above-mentioned patent applications is hereby incorporated by reference herein and made a part of specification.

### BACKGROUND OF THE INVENTION

1. Field of the Invention

The present invention generally relates to a method and a device for controlling an electronic device, and more particularly, to a method and a device for controlling an electronic device having a touch screen.

2. Description of Related Art

Along with the development of the touch control technology, touch control devices have been disposed in many electronic products as input devices. For example, most mobile electronic devices are designed very small in order to achieve a high portability. Accordingly, by using a touch screen as the input/output device of such a mobile electronic device, not only the space required by a physical keyboard can be saved, but the image display can be enlarged.

However, in order to avoid touching the touch screen and accordingly causing an electronic device to execute a specific function accidently, a user can switch the electronic device to a screen lock state when the electronic device is not in use, and the electronic device can automatically switch to the screen lock state in some situations (for example, when the user is making a phone call by using the electronic device or after the electronic device has been idle for a long time). Thus, no misoperation will be executed even if the user accidently touches the touch screen. When subsequently the electronic device is to be used, the user has to perform a specific unlocking operation to switch the electronic device away from the screen lock state. Obviously, when the user uses the electronic device, the user needs to switch the electronic device to different states frequently. Thereby, how to provide a more intuitional and convenient operation technique has become a major subject when manufacturers develop their products.

### SUMMARY OF THE INVENTION

Accordingly, the present invention is directed to a control method and a control device that allow a user to switch the state of an electronic device conveniently.

The present invention provides a method for controlling an electronic device having a touch screen. The present method includes displaying a plurality of first type sub-images on the touch screen at an original angle when the electronic device is in a first state, where the first type sub-images constitute a first operation screen of the first state. The present method also includes detecting a sliding operation performed on the touch screen and flipping at least one of the first type sub-images according to the sliding operation. The present method further includes flipping all the first type sub-images to a maximum angle to display a second operation screen of a second state of the electronic device and switching the electronic device from the first state to the second state when the sliding operation corresponds to a specific gesture.

The present invention provides a device for controlling an electronic device having a touch screen. The control device includes a screen display module, a detection module, a flipping module, and a switching module. When the electronic device is in a first state, the screen display module displays a plurality of first type sub-images on the touch screen at an original angle, where all the first type sub-images constitute a first operation screen of the first state. The detection module detects a sliding operation performed on the touch screen. The flipping module flips at least one of the first type sub-images according to the sliding operation. When the sliding operation corresponds to a specific gesture, the switching module flips all the first type sub-images to a maximum angle to display a second operation screen of a second state of the electronic device and switches the electronic device from the first state to the second state.

As described above, the present invention provides a method and a device for controlling an electronic device having a touch screen. According to the present invention, the state of the electronic device can be switched according to a gesture performed by a user on the touch screen, and operation screens of different states are presented when the state of the electronic device is switched. Thereby, the user can preview the operation screen of another state when the state of the electronic device is switched.

These and other exemplary embodiments, features, aspects, and advantages of the invention will be described and become more apparent from the detailed description of exemplary embodiments when read in conjunction with accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of an electronic device according to an embodiment of the present invention.

FIG. 2 is a block diagram of a control device according to an embodiment of the present invention.

FIG. 3 is a flowchart of a control method according to an embodiment of the present invention.

FIG. 4A is a top view of a first type sub-images according to an embodiment of the present invention.

FIG. 4B, FIG. 4C, and FIG. 4D are side views of a first type sub-images according to an embodiment of the present invention.

FIG. 5 is a diagram illustrating how a touch screen displays first type sub-images according to an embodiment of the present invention.

FIG. 6 is a diagram illustrating first type sub-images and rotational axes and operating directions thereof according to an embodiment of the present invention.

FIGS. 7A-7G are diagrams illustrating a control method according to an embodiment of the present invention.

FIGS. 8A-8G are diagrams illustrating a control method according to another embodiment of the present invention.

FIGS. 9A-9G are diagrams illustrating a control method according to yet another embodiment of the present invention.

### DESCRIPTION OF THE EMBODIMENTS

Reference will now be made in detail to the present preferred embodiments of the invention, examples of which are illustrated in the accompanying drawings.

Wherever possible, the same reference numbers are used in the drawings and the description to refer to the same or like parts.

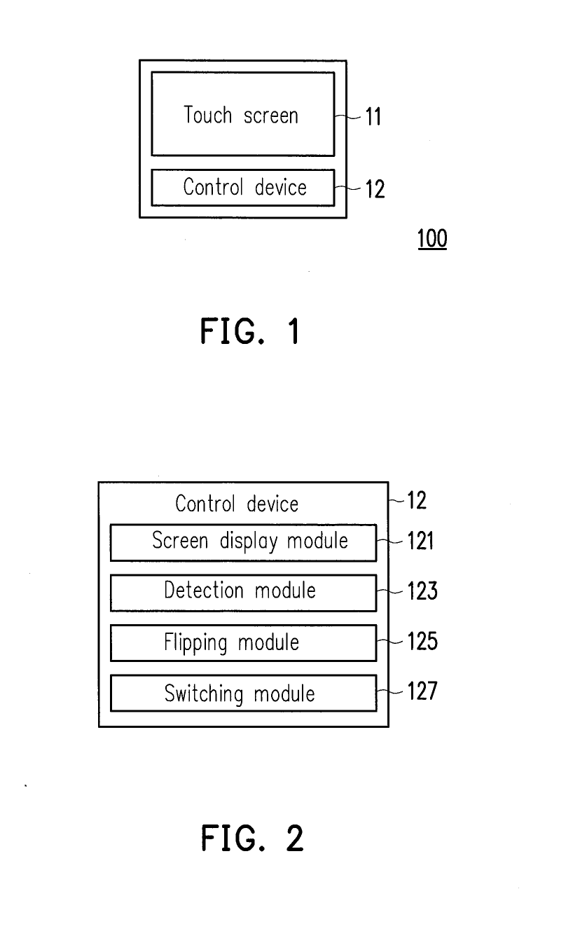

FIG. 1 is a diagram of an electronic device according to an embodiment of the present invention. Referring to FIG. 1, the electronic device 100 in the present embodiment may be a cell phone, a smart phone, a personal digital assistant (PDA), a tablet PC, a game console, or an e-book. However, the type of the electronic device 100 is not limited herein. The electronic device 100 includes a touch screen 11 and a control device 12.

The touch screen 11 may be a resistive touch screen, a capacitive touch screen, an optical touch screen, or an ultrasound touch screen. However, the type of the touch screen 11 is not limited herein. The touch screen 11 receives the touch operations performed by a user and displays different operation screens of the electronic device 100.

The control device 12 is a software or hardware device disposed in the electronic device 100. The control device 12 identifies a touch operation received by the touch screen 11 and switches the electronic device 100 between different states according to the received touch operation.

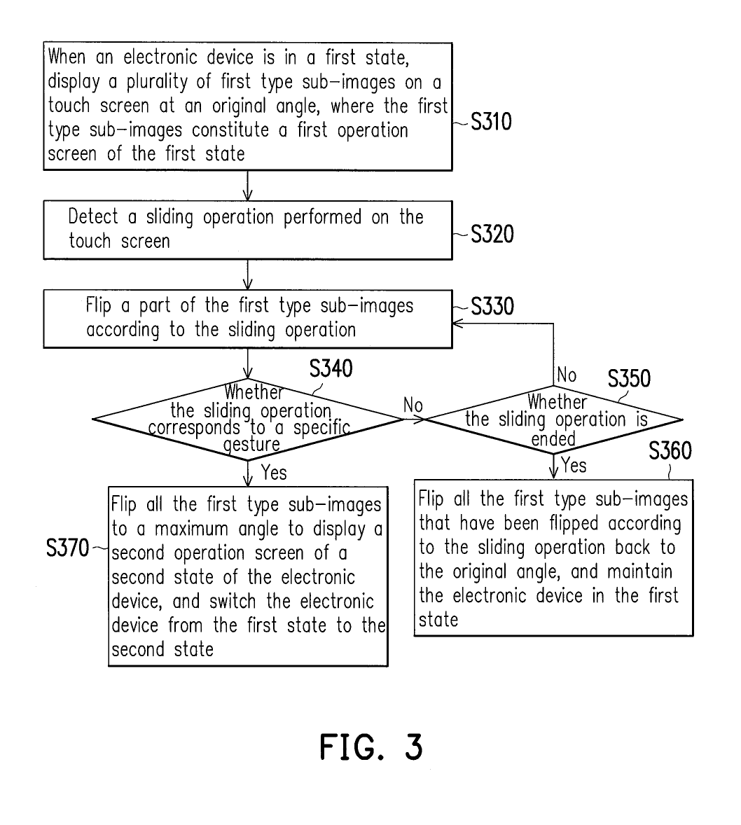

Below, various components and the functions thereof in the control device 12 will be described with reference to FIG. 2. As shown in FIG. 2, the control device 12 includes a screen display module 121, a detection module 123, a flipping module 125, and a switching module 127. Foregoing modules may be hardware devices implemented by using logic circuit components for accomplishing the state switching function of the electronic device 100. However, the present invention is not limited thereto, and foregoing modules may also be programs stored in a storage medium of the electronic device 100. These programs can be loaded into a processor of the electronic device 100 to accomplish the state switching function of the electronic device 100.

FIG. 3 is a flowchart of a control method according to an embodiment of the present invention. Referring to FIGS. 1-3, the control method in the present embodiment is adapted to the control device 12 and will be described below with reference to various components of the control device 12. In the present embodiment, the electronic device 100 has at least a first state and a second state, where the first state may be a screen lock state, and the second state may be a screen unlock state.

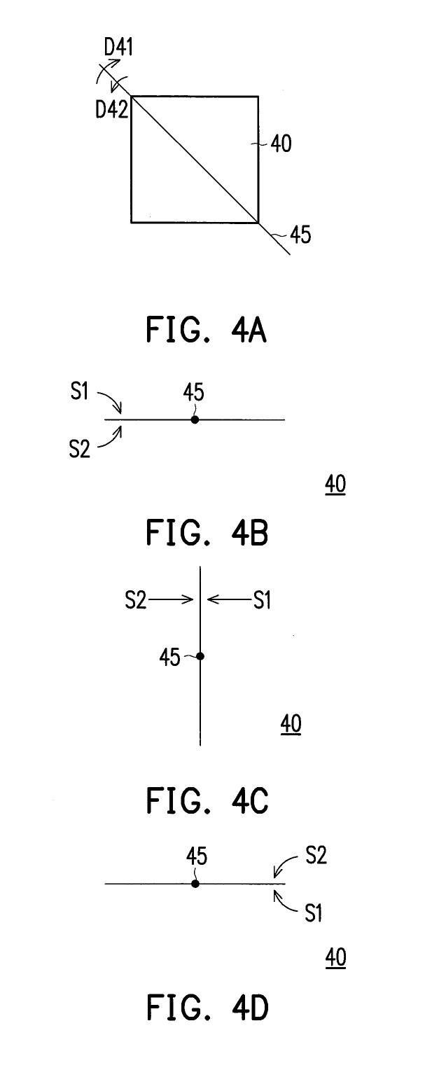

First, in step S310, when the electronic device 100 is in the first state, the screen display module 121 displays a plurality of first type sub-images on the touch screen 11 at an original angle, and these first type sub-images constitute a first operation screen of the first state. In the present embodiment, each first type sub-image can be flipped along a rotational axis, and the original angle refers to the angle of the first type sub-image before it is flipped. FIG. 4A is a top view of a first type sub-image according to an embodiment of the present invention. Herein it is assumed that the first type sub-image 40 is a square, and which can be flipped along the rotational axis 45 toward a first direction D41 or a second direction D42. Below, how the first type sub-image 40 is flipped along the rotational axis 45 toward the first direction D41 will be explained with reference to the top views of the first type sub-image 40 in FIGS. 4B-4C. FIG. 4B illustrates the state of the first type sub-image 40 before it is flipped, where the first surface S1 faces upwards and the second surface S2 faces downwards. Herein the first type sub-image 40 is displayed at an original angle, and below, the original angle will be defined as 0°. After the first type sub-image 40 is flipped for 90° along the rotational axis 45 toward the first direction D41, as shown in FIG. 4C, the first surface S1 faces rightwards, and the second surface S2 faces leftwards. After the first type sub-image 40 is flipped for 180° along the rotational axis 45 toward the first direction D41, as shown in FIG. 4D, the first surface S1 faces downwards, and the second surface S2 faces upwards. The rotational axis 45 and the first direction D41 are only taken as examples for describing the present embodiment but not intended to limit the scope of the present invention.

Next, in step S320, the detection module 123 detects a sliding operation performed on the touch screen 11. In step S330, the flipping module 125 flips part of the first type sub-images according to the sliding operation. To be specific, the flipping module 125 selects one or more first type sub-images among all the first type sub-images and flips the selected first type sub-images at their original positions. Or, the flipping module 125 may also flips the selected first type sub-images and moves the selected first type sub-images outwards. Below, how the flipping module 125 flips part of the first type sub-images according to the sliding operation will be explained in detail.

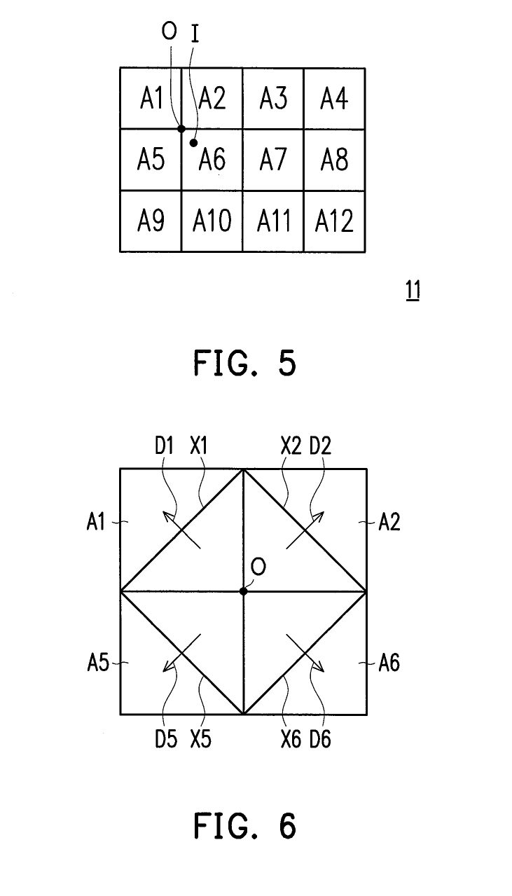

In an embodiment, the flipping module 125 first determines a representative point representing a start position of the sliding operation on the touch screen 11. Herein the flipping module 125 takes the cross point of the borders of the first type sub-images which are closest to the start position as the representative point. For example, as shown in FIG. 5, assuming that 12 first type sub-images A1-A12 are displayed on the touch screen 11, because the start position I of the sliding operation is closest to the cross point of the borders of the first type sub-images A1, A2, A5, and A6, the flipping module 125 defines this cross point as a representative point O.

After that, the flipping module 125 selects a plurality of to-be-flipped first type sub-images among all the first type sub-images according to a displacement of the sliding operation and the representative point. To be specific, the flipping module 125 calculates the relative distance between each first type sub-image and the representative point (for example, the linear distance between the center point of the first type sub-image and the representative point) and obtains the displacement of the sliding operation relative to the representative point. After that, the flipping module 125 selects those first type sub-images with the corresponding relative distances not greater than the displacement among all the first type sub-images as the to-be-flipped first type sub-images.

In the present embodiment, the flipping module 125 flips the to-be-flipped first type sub-images that have the same distance to the representative point for a same angle at their original positions. To be specific, regarding each to-be-flipped first type sub-image, the flipping module 125 calculates the flip angle of the to-be-flipped first type sub-image according to the displacement of the sliding operation relative to the representative point, the relative distance between to-be-flipped first type sub-image and the representative point, and a first predetermined constant. For example, the flipping module 125 calculates the flip angle A of each to-be-flipped first type sub-image through following expression (1):

A=(R−D)×C₁ (1)

In foregoing expression (1), R is the displacement of the sliding operation, D is the relative distance between the first type sub-image and the representative point, and C₁ is the first predetermined constant (for example, 0.5, not limited in the present invention). Besides, regarding each to-be-flipped first type sub-image, the flipping module 125 also determines a rotational axis and an operating direction of the to-be-flipped first type sub-image according to the relative position between the to-be-flipped first type sub-image and the representative point. In the present embodiment, the first type sub-images are squares, and the flipping module 125 can serve any diagonal line as the rotational axis of a to-be-flipped first type sub-image. For example, in the two diagonal lines of each to-be-flipped first type sub-image, the flipping module 125 selects the diagonal line that will never meet the representative point even if inconceivably extended as the rotational axis. The operating direction is a direction perpendicular to rotational axis and outwardly leaving the representative point. For example, as shown in FIG. 6, it is assumed that the first type sub-images A1, A2, A5, and A6 are selected as the to-be-flipped first type sub-images after the representative point O is determined. Taking the first type sub-image A1 as an example, the flipping module 125 serves the diagonal line X1 of the first type sub-image A1 as its rotational axis and defines the operating direction D1. Taking the first type sub-image A2 as an example, the flipping module 125 serves the diagonal line X2 of the first type sub-image A2 as its rotational axis and defines the operating direction D2. Taking the first type sub-image A5 as an example, the flipping module 125 serves the diagonal line X5 of the first type sub-image A5 as its rotational axis and defines the operating direction D5. Taking the first type sub-image A6 as an example, the flipping module 125 serves the diagonal line X6 of the first type sub-image A6 as its rotational axis and defines the operating direction D6. As shown in FIG. 6, the diagonal lines X1, X2, X5, and X6 served as rotational axes do not meet the representative point O even when they are extended, and the operating directions D1, D2, D5, and D6 are perpendicular to the corresponding rotational axes and outwardly leaving the representative point O.

Regarding each to-be-flipped first type sub-image, the flipping module 125 determines whether the flip angle calculated through foregoing expression (1) is greater than a maximum angle. In the present embodiment, the maximum angle is 180°. When the flip angle is not greater than the maximum angle, the flipping module 125 flips the to-be-flipped first type sub-image for the flip angle along the rotational axis thereof and toward the operating direction thereof. While when the flip angle is greater than the maximum angle, the flipping module 125 flips the to-be-flipped first type sub-image for the maximum angle along the rotational axis thereof and toward the operating direction thereof.

In another embodiment, after the flipping module 125 selects the to-be-flipped first type sub-images and when the flipping module 125 flips the to-be-flipped first type sub-images that have the same distance to the representative point for the same angle, the flipping module 125 further moves the to-be-flipped first type sub-images that have the same distance to the representative point toward the corresponding operating directions for a same distance. Namely, the flipping module 125 both flips the to-be-flipped first type sub-images that have the same distance to the representative point for the same angle and moves these to-be-flipped first type sub-images outwards for the same distance.

To be specific, regarding each to-be-flipped first type sub-image, the flipping module 125 calculates the flip angle of the to-be-flipped first type sub-image according to the displacement of the sliding operation relative to the representative point, the relative distance between the to-be-flipped first type sub-image and the representative point, and the first predetermined constant and determines the rotational axis and the operating direction of the to-be-flipped first type sub-image according to the relative position between the to-be-flipped first type sub-image and the representative point. The calculation of the flip angle and the determination of the rotational axis and the operating direction are similar to those described in foregoing embodiment therefore will not be described herein. In the present embodiment, the flipping module 125 further calculates an offset distance of each to-be-flipped first type sub-image according to the displacement, the relative distance, and a second predetermined constant. For example, the flipping module 125 calculates the offset distance Dm of each to-be-flipped first type sub-image by using following expression (2):

Dm=(R−D)×C₂ (2)

In foregoing expression (2), R is the displacement of the sliding operation, D is the relative distance between the first type sub-image and the representative point, and C₂ is the second predetermined constant (for example, 0.3, not limited in the present invention).

Regarding each to-be-flipped first type sub-image, the flipping module 125 determines whether the flip angle of the to-be-flipped first type sub-image is greater than the maximum angle. In the present embodiment, the maximum angle is 90°. When the flip angle is not greater than the maximum angle, the flipping module 125 flips the to-be-flipped first type sub-image for the flip angle along the rotational axis and toward the operating direction and moves the to-be-flipped first type sub-image for the offset distance. When the flip angle is greater than the maximum angle, the flipping module 125 flips the to-be-flipped first type sub-image for the maximum angle along the rotational axis and toward the operating direction and moves the to-be-flipped first type sub-image for the offset distance.

In step S340 of FIG. 3, the switching module 127 determines whether the sliding operation corresponds to a specific gesture. In an embodiment, the start position of the sliding operation is any position on the touch screen 11, and the switching module 127 determines that the sliding operation corresponds to the specific gesture once the displacement of the sliding operation reaches a predetermined value. Herein the predetermined value is 200 pixels. However, the present invention is not limited thereto. In another embodiment, the switching module 127 only determines that the sliding operation corresponds to the specific gesture when the start position of the sliding operation is within a specific area (for example, an area for displaying a state switching icon) on the touch screen 11 and the displacement of the sliding operation reaches the predetermined value.

If the switching module 127 determines that the sliding operation does not correspond to the specific gesture, in step S350, the switching module 127 determines whether the sliding operation is ended. If the sliding operation is not yet ended, the procedure in the present embodiment returns to step S330.

If the sliding operation is already ended, in step S360, the flipping module 125 flips all the first type sub-images that have been flipped according to the sliding operation back to the original angle and maintains the electronic device 100 in the first state. Namely, the flipping module 125 restores all the first type sub-images back to the non-flipped state to display the first operation screen of the first state of the electronic device 100.

If the switching module 127 determines that the sliding operation corresponds to the specific gesture, in step S370, the switching module 127 flips all the first type sub-images to the maximum angle to display a second operation screen of the second state of the electronic device 100 and switches the electronic device 100 from the first state to the second state.

In an embodiment, the second operation screen is composed of a plurality of second type sub-images, and the first type sub-images and the second type sub-images are in one-to-one correspondence. To be specific, the back of each first type sub-image is the corresponding second type sub-image. When the switching module 127 flips all the first type sub-images to the maximum angle to display the second operation screen, the switching module 127 flips each first type sub-image to its back to display the corresponding second type sub-image.

In another embodiment, once the switching module 127 determines that the sliding operation corresponds to the specific gesture, the switching module 127 displays a state switching prompt effect at the start position of the sliding operation. The state switching prompt effect may be a halo, a state switching icon, a text prompt, or an animation prompt. Through the state switching prompt effect, a user can be aware that the electronic device 100 is in a state switching process.

In yet another embodiment, when the electronic device 100 is in the first state, the first operation screen completely covers the second operation screen. When the switching module 127 flips all the first type sub-images to the maximum angle to display the second operation screen, the switching module 127 allows each first type sub-image to disappear when the first type sub-image is flipped to the maximum angle, so as to expose the second operation screen under the first operation screen.

Below, how the state of the electronic device 100 is switched under the control of the control device 12 will be described with reference to several embodiments.

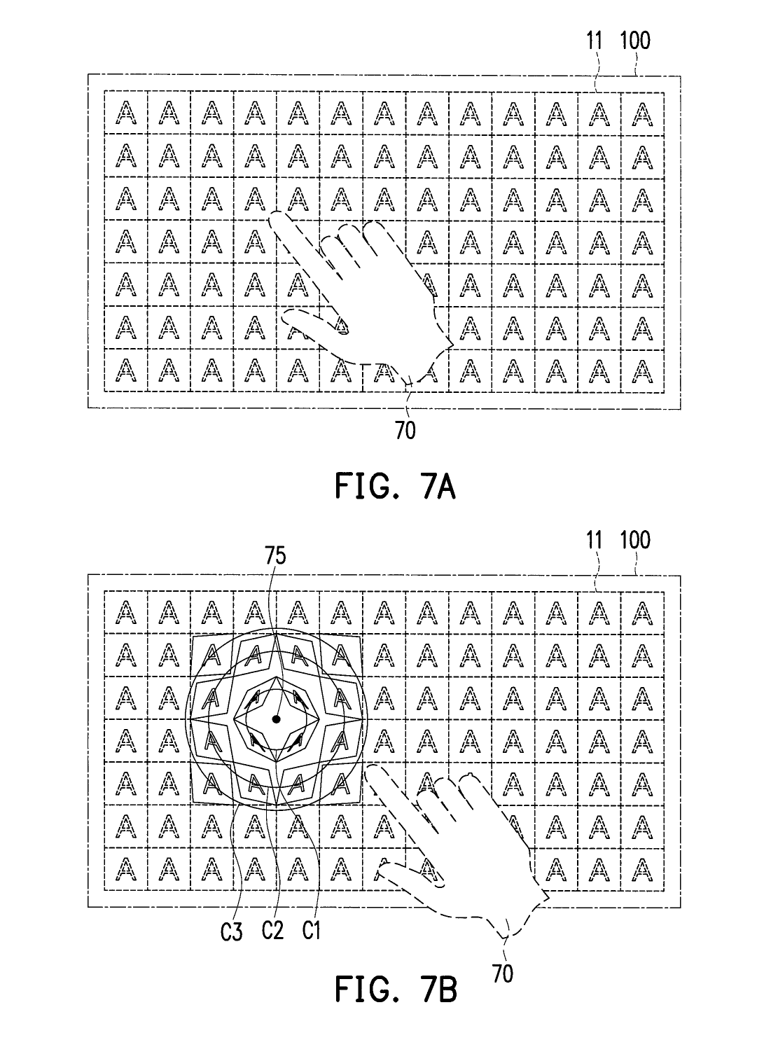

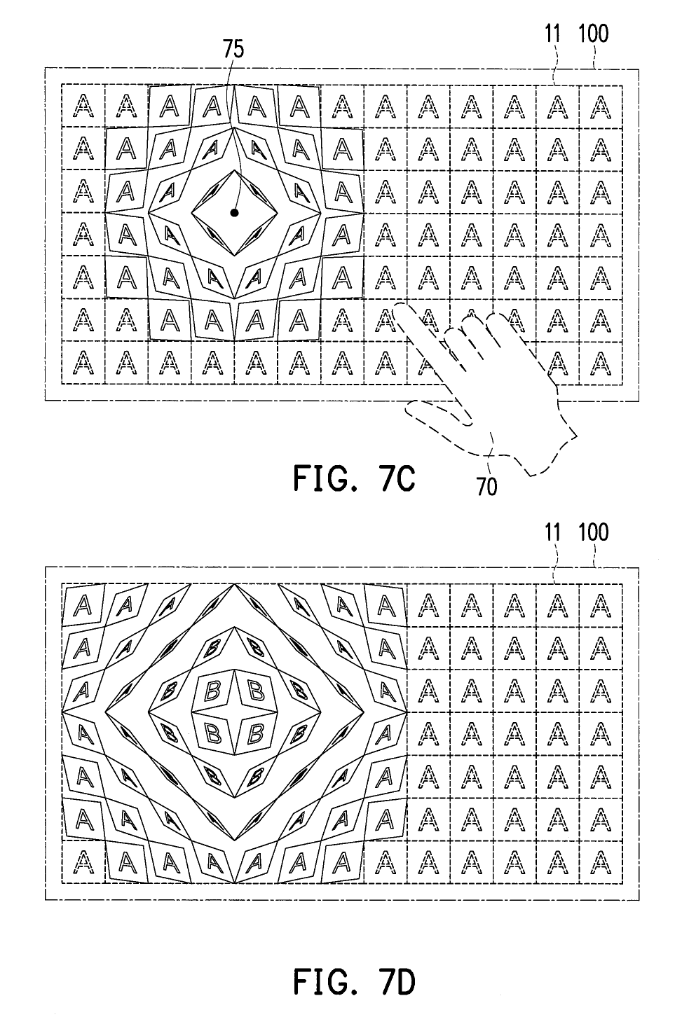

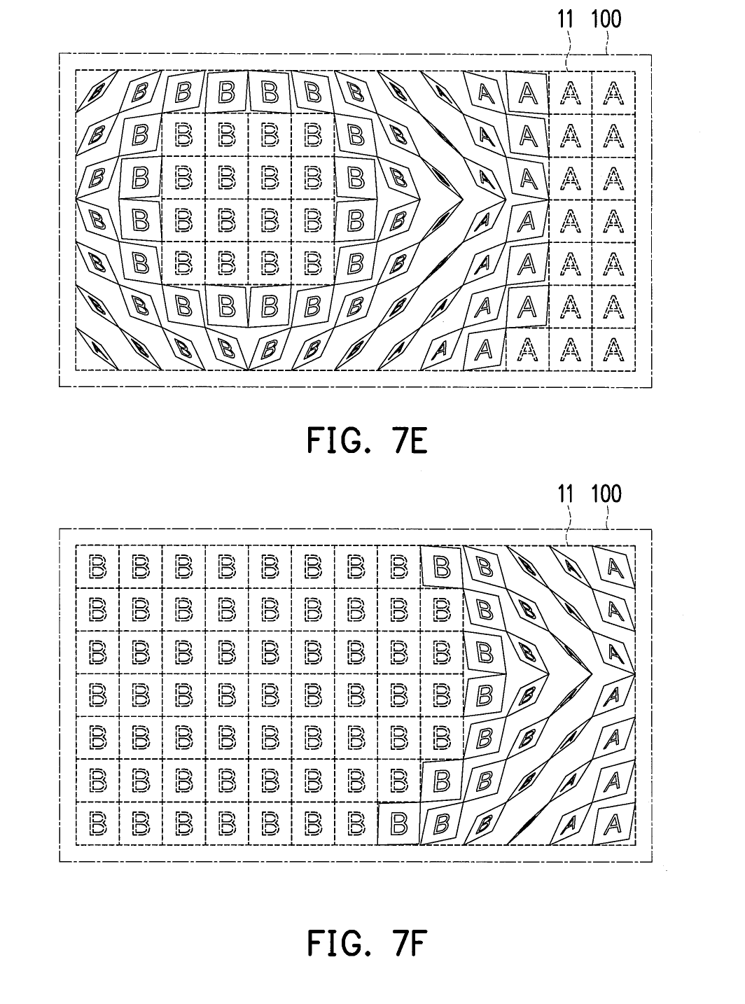

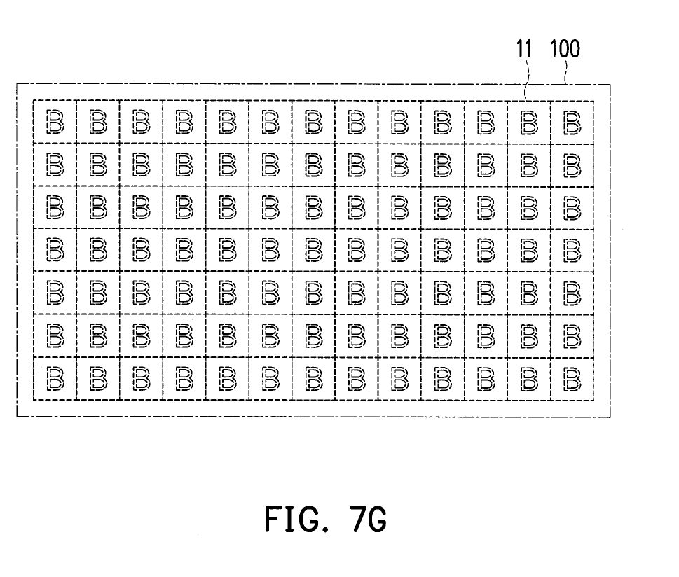

FIGS. 7A-7G are diagrams illustrating a control method according to an embodiment of the present invention. First, as shown in FIG. 7A, when the electronic device 100 is in the first state, the touch screen 11 displays a plurality of first type sub-images A that constitutes a first operation screen of the first state. In the present embodiment, the back of each first type sub-image A is a corresponding second type sub-image B, and all the second type sub-images B constitute a second operation screen of a second state of the electronic device 100. When a user uses his hand 70 to touch the touch screen 11 and moves his hand 70 both downwards and rightwards to perform a sliding operation, as shown in FIG. 7B, 16 first type sub-images A are flipped according to the sliding operation. The first type sub-images A that have the same distance to the representative point 75 (representing the start position of the sliding operation) are flipped for the same angle. To be specific, with the increase of the displacement of the sliding operation, the datum circumference with the representative point 75 as its center expands constantly outwards. The four first type sub-images A having their center points on the datum circumference C1 have a same flip angle, the eight first type sub-images A having their center points on the datum circumference C2 have a same flip angle, and the four first type sub-images A having their center point on the datum circumference C3 have a same flip angle.

As shown in FIG. 7C, when the sliding operation is not yet ended, more first type sub-images A (32 first type sub-images A) are flipped according to the sliding operation. Similarly, those first type sub-images A having the same distance to the representative point 75 are flipped for the same angle. If herein the displacement of the sliding operation already reaches a predetermined value (i.e., the sliding operation corresponds to a specific gesture) and the user moves his hand 70 away from the touch screen 11, as shown in FIGS. 7D-7G, those first type sub-images A that are not yet flipped are automatically flipped to a maximum angle (for example, 180°), so that a plurality of second type sub-images B constituting the second operation screen of the second state of the electronic device 100 is displayed, and the electronic device 100 is switched to the second state. In the present embodiment, after the sliding operation is determined to correspond to the specific gesture, the datum circumference keeps expanding outwards, and those first type sub-images A having their center points on the same datum circumferences are simultaneously flipped to display the corresponding second type sub-images B.

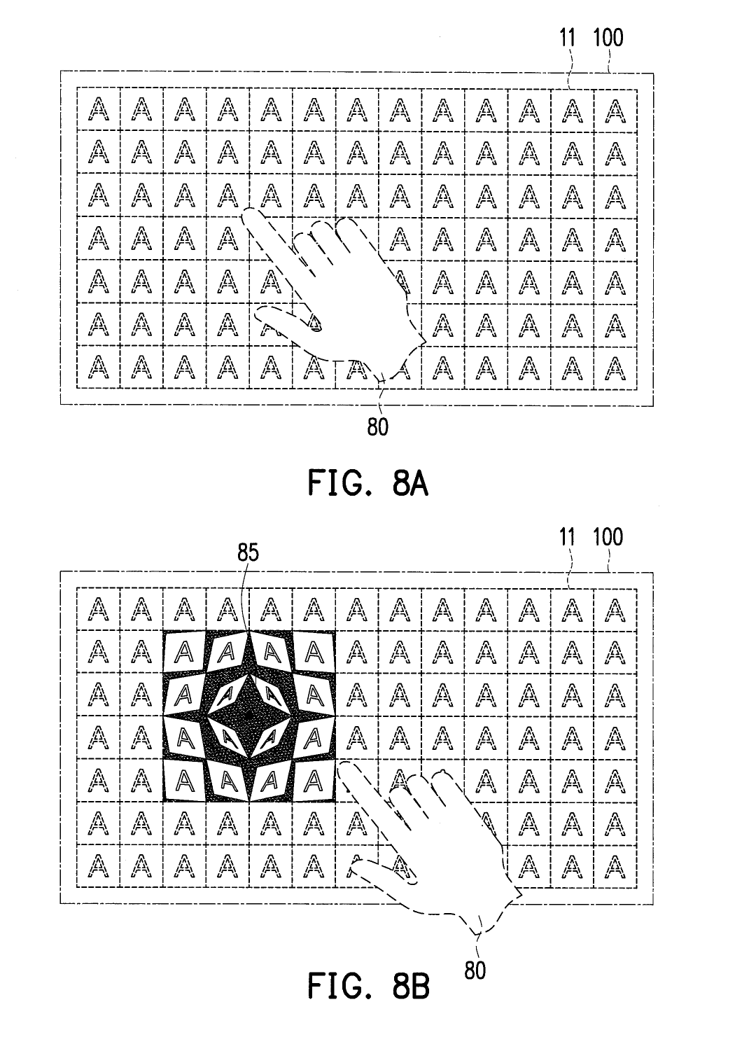

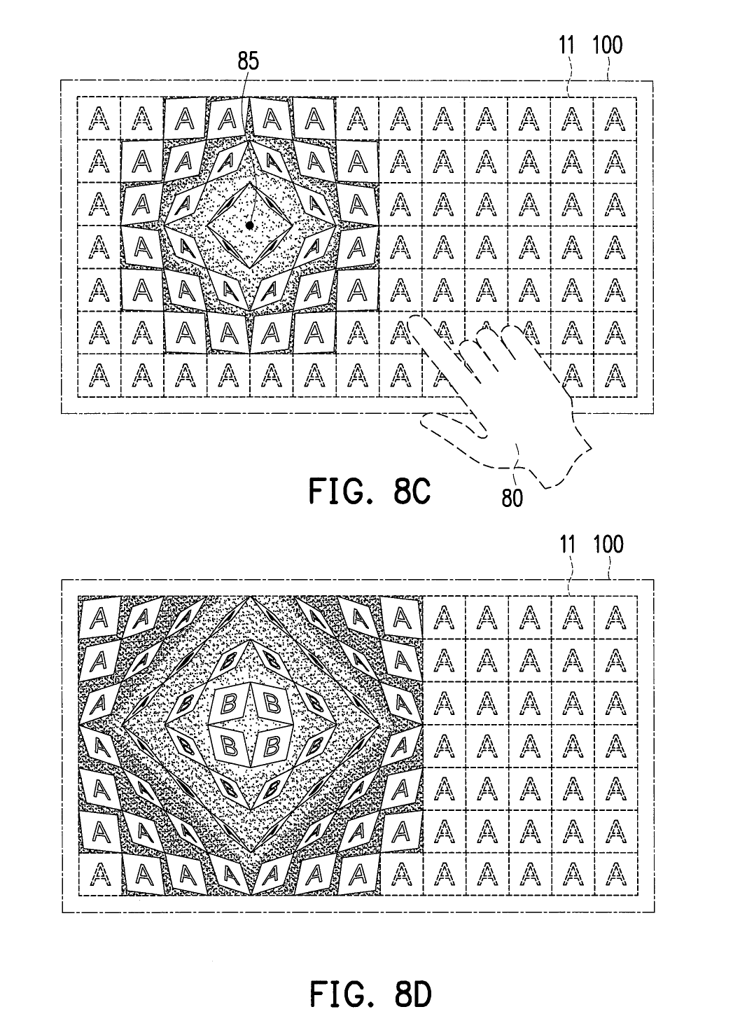

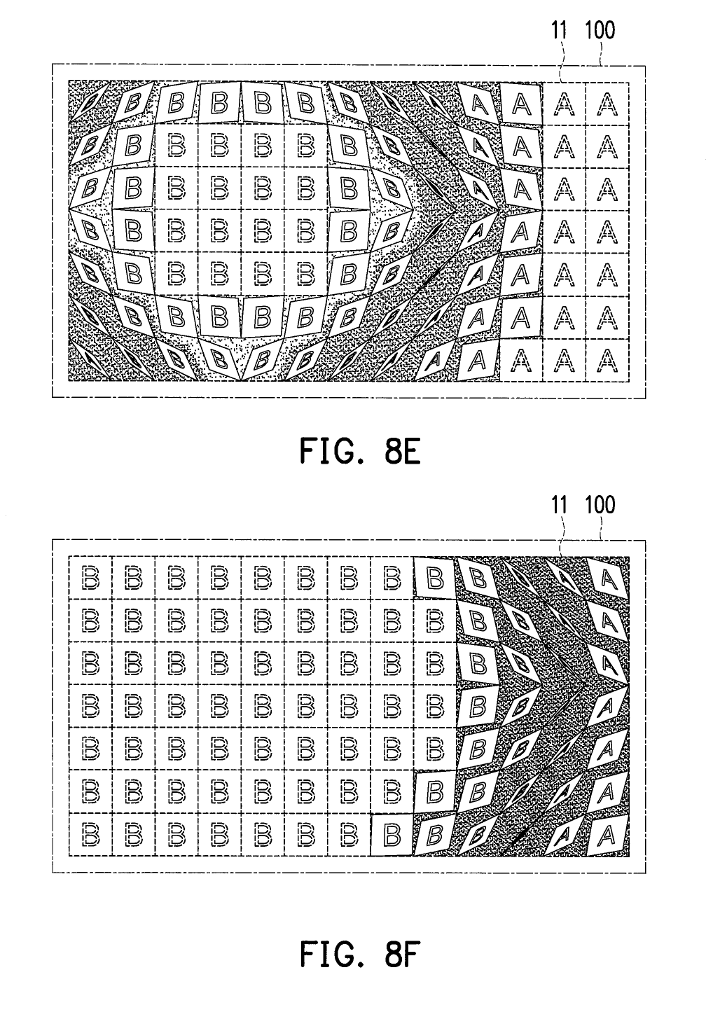

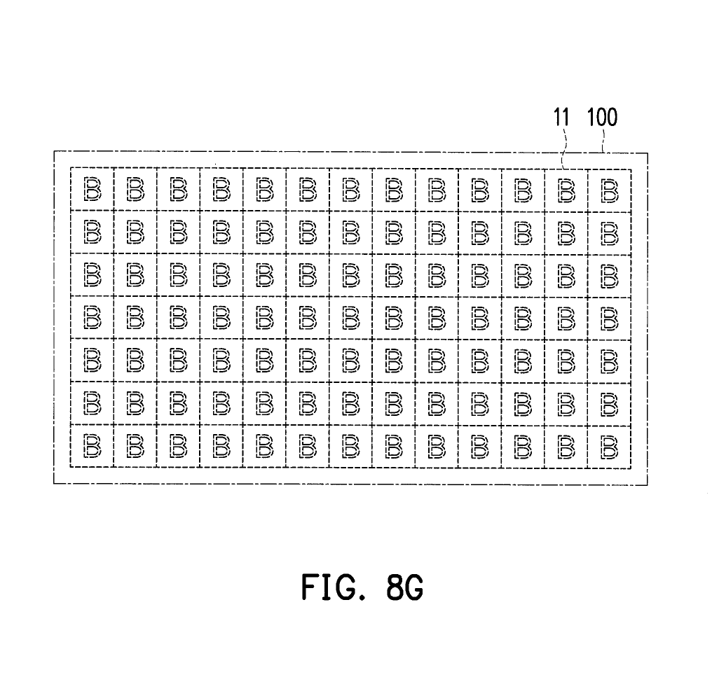

FIGS. 8A-8G are diagrams illustrating a control method according to another embodiment of the present invention. First, as shown in FIG. 8A, when the electronic device 100 is in a first state, the touch screen 11 displays a plurality of first type sub-images A that constitutes a first operation screen of the first state. In the present embodiment, the back of each first type sub-image A is a corresponding second type sub-image B, and all the second type sub-images B constitute a second operation screen of a second state of the electronic device 100. When a user uses his hand 80 to touch the touch screen 11 and moves his hand 80 both downwards and rightwards to perform a sliding operation, as shown in FIG. 8B, 16 first type sub-images A are flipped according to the sliding operation. Similar to that in the embodiment described above, in the present embodiment, those first type sub-images A having the same distance to the representative point 85 (representing the start position of the sliding operation) are flipped for the same angle.

As shown in FIG. 8C, when the sliding operation is not yet ended, more first type sub-images A (32 first type sub-images A) are flipped according to the sliding operation. If herein the displacement of the sliding operation already reaches a predetermined value (i.e., the sliding operation corresponds to a specific gesture), the electronic device 100 displays a halo at the representative point 85 as a state switching prompt effect. Subsequently, when the user moves his hand 80 away from the touch screen 11, as shown in FIGS. 8D-8G, those first type sub-images A that are not yet flipped are automatically flipped to a maximum angle (for example, 180°), so that a plurality of second type sub-images B constituting the second operation screen of the second state of the electronic device 100 is displayed, and the electronic device 100 is switched to the second state. The flipping of the first type sub-images A is similar to that described in foregoing embodiment therefore will not be described herein.

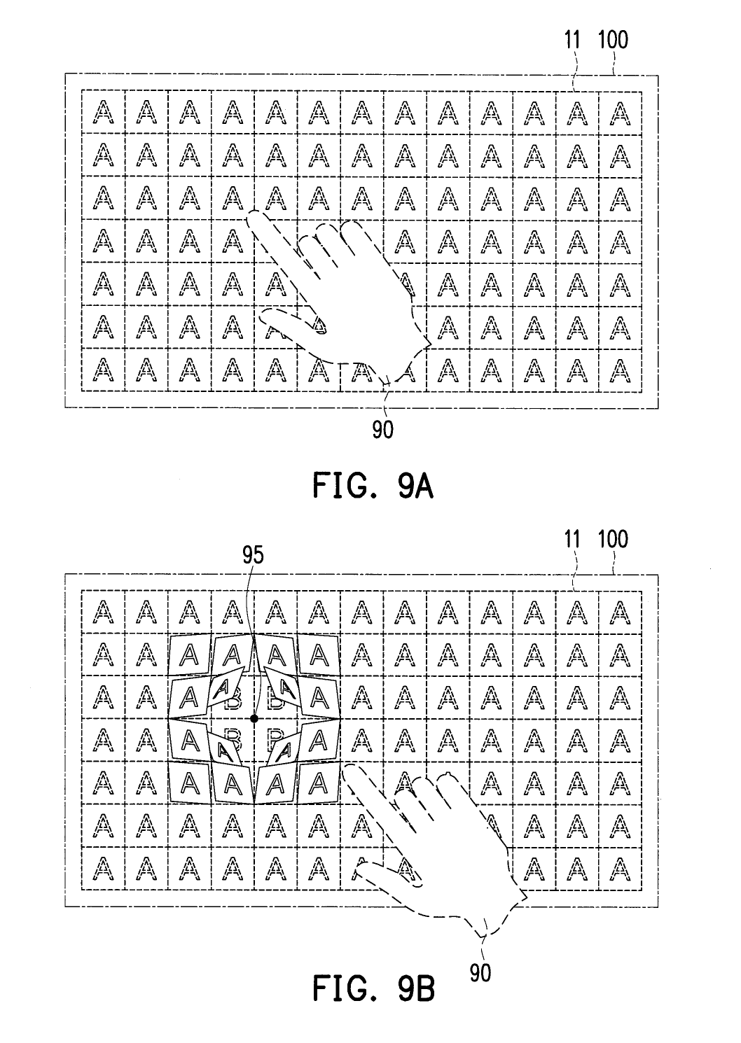

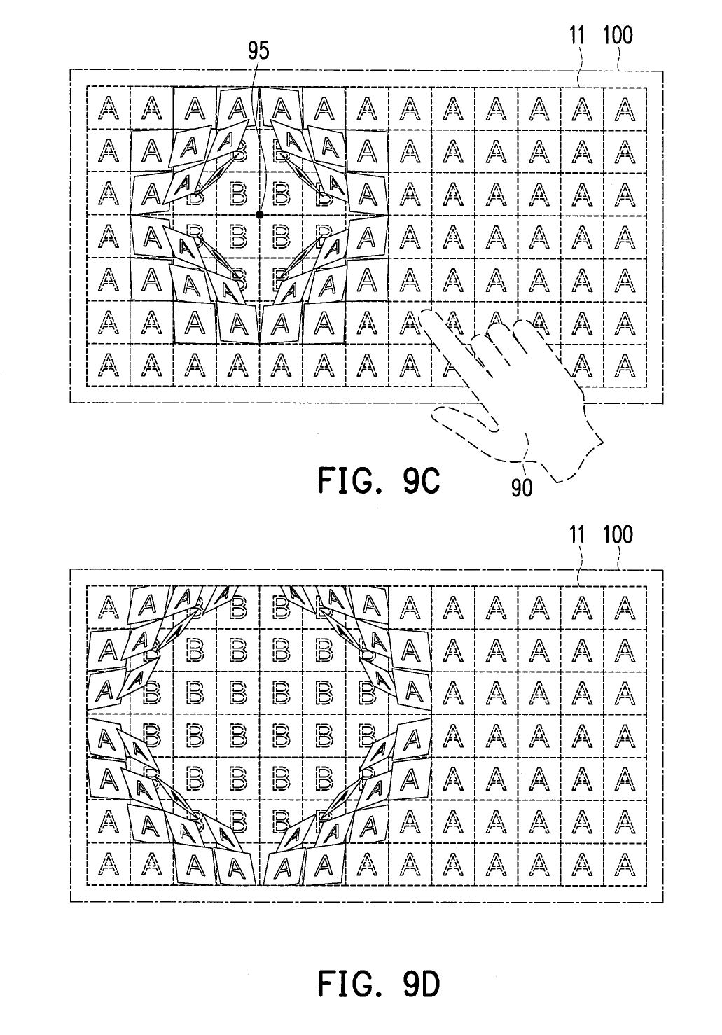

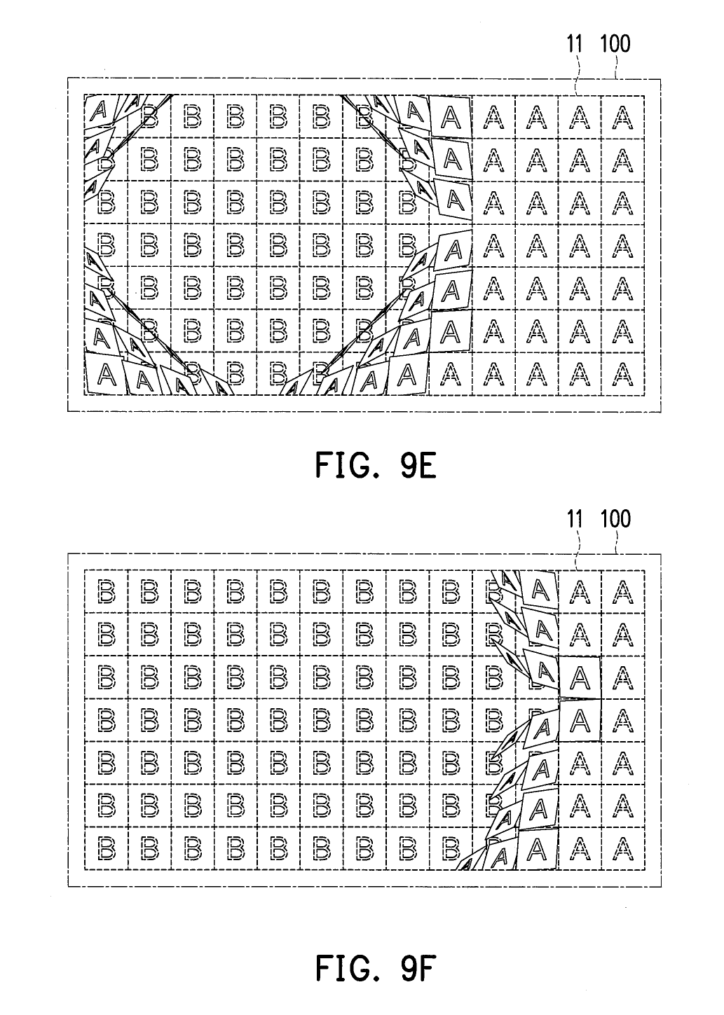

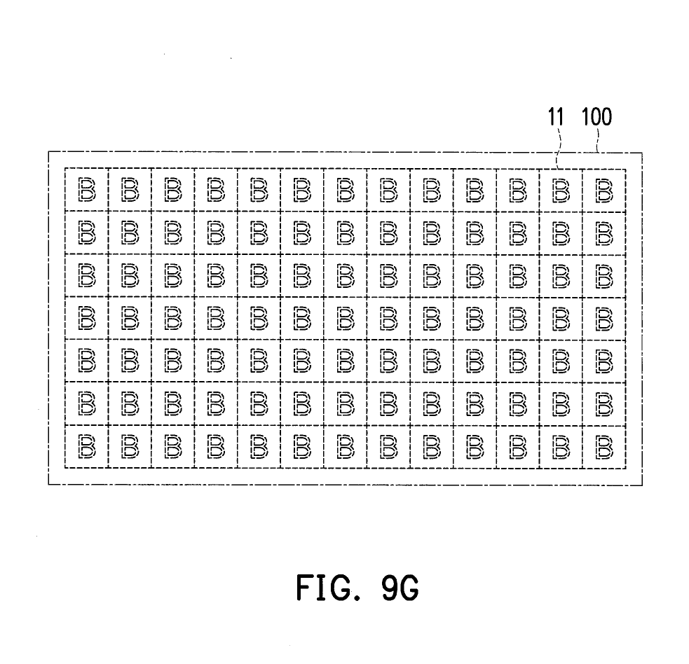

FIGS. 9A-9G are diagrams illustrating a control method according to yet another embodiment of the present invention. First, as shown in FIG. 9A, when the electronic device 100 is in a first state, the touch screen 11 displays a plurality of first type sub-images A that constitutes a first operation screen of the first state. Herein the first operation screen completely covers a second operation screen of the electronic device 100, and the second operation screen is composed of a plurality of second type sub-images B. When a user uses his hand 90 to touch the touch screen 11 and moves his hand 90 both downwards and rightwards to perform a sliding operation, as shown in FIG. 9B, 16 first type sub-images A are flipped according to the sliding operation and moved outwards. In the present embodiment, those first type sub-images A having the same distance to the representative point 95 (representing the start position of the sliding operation) are flipped for the same angle and are moved outwards from the representative point 95 for the same distance. The originally covered second type sub-images B are displayed after the first type sub-images A are flipped and moved outwards.

As shown in FIG. 9C, when the sliding operation is not ended yet, more first type sub-images A (32 first type sub-images A) are flipped and moved outwards according to the sliding operation. If herein the displacement of the sliding operation already reaches a predetermined value (i.e., the sliding operation corresponds to a specific gesture), when the user moves his hand 90 away from the touch screen 11, as shown in FIGS. 9D-9G, those first type sub-images A that are not yet flipped are automatically flipped and moved outwards, where each first type sub-image A disappears when it is flipped to a maximum angle (for example, 90°), and the electronic device 100 is switched to the second state.

As described above, in a control method and a control device provided by the present invention, an intuitional and interesting state switching technique is provided, and which allows a user to switch the state of an electronic device through a touch screen. Additionally, in the control method and the control device provided by the present invention, a special switching effect is presented during the state switching process, such that a user can preview the operation screen after the state is switched during the state switching process.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for controlling an electronic device having a touch screen, the method comprising:
when the electronic device is in a first state, displaying a plurality of first type sub-images on the touch screen at an original angle, wherein the first type sub-images constitute a first operation screen of the first state;
detecting a sliding operation performed on the touch screen;
flipping at least one of the first type sub-images according to the sliding operation; and
when the sliding operation corresponds to a specific gesture, flipping all the first type sub-images to a maximum angle to display a second operation screen of a second state of the electronic device, and switching the electronic device from the first state to the second state.

2. The control method according to claim 1, wherein the step of flipping at least one of the first type sub-images according to the sliding operation comprises:
determining a representative point representing a start position of the sliding operation on the touch screen;
selecting a plurality of to-be-flipped first type sub-images among the first type sub-images according to a displacement of the sliding operation and the representative point; and
flipping the to-be-flipped first type sub-images that have a same distance to the representative point among the to-be-flipped first type sub-images for a same angle.

3. The control method according to claim 2, wherein the step of selecting the to-be-flipped first type sub-images among the first type sub-images according to the displacement of the sliding operation and the representative point comprises:
calculating a relative distance between each of the first type sub-images and the representative point;
obtaining the displacement of the sliding operation relative to the representative point; and
selecting the first type sub-images with the corresponding relative distances not greater than the displacement among the first type sub-images as the to-be-flipped first type sub-images.

4. The control method according to claim 3, wherein the step of flipping the to-be-flipped first type sub-images that have the same distance to the representative point among the to-be-flipped first type sub-images for the same angle comprises:
regarding each of the to-be-flipped first type sub-images, calculating a flip angle according to the displacement, the relative distance, and a first predetermined constant, and determining a rotational axis and an operating direction according to a relative position between the to-be-flipped first type sub-image and the representative point;
when the flip angle is not greater than the maximum angle, flipping the to-be-flipped first type sub-image for the flip angle along the rotational axis and toward the operating direction; and
when the flip angle is greater than the maximum angle, flipping the to-be-flipped first type sub-image for the maximum angle along the rotational axis and toward the operating direction.

5. The control method according to claim 2, wherein the step of flipping the to-be-flipped first type sub-images that have the same distance to the representative point among the to-be-flipped first type sub-images for the same angle comprises:
regarding each of the to-be-flipped first type sub-images, calculating a flip angle according to the displacement, the relative distance, and a first predetermined constant, calculating a offset distance according to the displacement, the relative distance, and a second predetermined constant, and determining a rotational axis and an operating direction according to a relative position between the to-be-flipped first type sub-image and the representative point;
when the flip angle is not greater than the maximum angle, flipping the to-be-flipped first type sub-image for the flip angle along the rotational axis and toward the operating direction, and moving the to-be-flipped first type sub-image for the offset distance; and
when the flip angle is greater than the maximum angle, flipping the to-be-flipped first type sub-image for the maximum angle along the rotational axis and toward the operating direction, and moving the to-be-flipped first type sub-image for the offset distance.

6. The control method according to claim 1, wherein the second operation screen comprises a plurality of second type sub-images, the first type sub-images and the second type sub-images have one-to-one correspondence, and a corresponding one of the second type sub-images is on a back of each of the first type sub-images, and the step of flipping all the first type sub-images to the maximum angle to display the second operation screen of the second state of the electronic device comprises:
flipping the first type sub-images to the backs to display the corresponding second type sub-images.

7. The control method according to claim 1, wherein when the electronic device is in the first state, the first operation screen completely covers the second operation screen, and the step of flipping all the first type sub-images to the maximum angle to display the second operation screen of the second state of the electronic device comprises:
allowing the first type sub-images to disappear when the first type sub-images are flipped to the maximum angle to display the second operation screen.

8. A device for controlling an electronic device having a touch screen, the device comprising:
a screen display module, displaying a plurality of first type sub-images on the touch screen at an original angle when the electronic device is in a first state, wherein the first type sub-images constitute a first operation screen of the first state;
a detection module, detecting a sliding operation performed on the touch screen;
a flipping module, flipping at least one of the first type sub-images according to the sliding operation; and
a switching module, when the sliding operation corresponds to a specific gesture, flipping all the first type sub-images to a maximum angle to display a second operation screen of a second state of the electronic device, and switching the electronic device from the first state to the second state.

9. The control device according to claim 8, wherein the flipping module determines a representative point representing a start position of the sliding operation on the touch screen, selects a plurality of to-be-flipped first type sub-images among the first type sub-images according to a displacement of the sliding operation and the representative point, and flipping the to-be-flipped first type sub-images that have a same distance to the representative point among the to-be-flipped first type sub-images for a same angle.

10. The control device according to claim 9, wherein the flipping module calculates a relative distance between each of the first type sub-images and the representative point, obtains the displacement of the sliding operation relative to the representative point, and selects the first type sub-images with the corresponding relative distances not greater than the displacement among the first type sub-images as the to-be-flipped first type sub-images.

11. The control device according to claim 10, wherein regarding each of the to-be-flipped first type sub-images, the flipping module calculates a flip angle according to the displacement, the relative distance, and a first predetermined constant and determines a rotational axis and an operating direction according to a relative position between the to-be-flipped first type sub-image and the representative point,
when the flip angle is not greater than the maximum angle, flips the to-be-flipped first type sub-image for the flip angle along the rotational axis and toward the operating direction, and when the flip angle is greater than the maximum angle, flips the to-be-flipped first type sub-image for the maximum angle along the rotational axis and toward the operating direction.

12. The control device according to claim 9, wherein when the flipping module flips the to-be-flipped first type sub-images that have the same distance to the representative point for the same angle, the flipping module further moves the to-be-flipped first type sub-images that have the same distance to the representative point toward an operating direction for a same distance.

13. The control device according to claim 12, wherein regarding each of the to-be-flipped first type sub-images, the flipping module calculates a flip angle according to the displacement, the relative distance, and a first predetermined constant, calculates an offset distance according to the displacement, the relative distance, and a second predetermined constant, and determines a rotational axis and the operating direction according to a relative position between the to-be-flipped first type sub-image and the representative point,
when the flip angle is not greater than the maximum angle, flips the to-be-flipped first type sub-image for the flip angle along the rotational axis and toward the operating direction, and moves the to-be-flipped first type sub-image for the offset distance, and when the flip angle is greater than the maximum angle, flips the to-be-flipped first type sub-image for the maximum angle along the rotational axis and toward the operating direction, and moves the to-be-flipped first type sub-image for the offset distance.

14. The control device according to claim 8, wherein the second operation screen comprises a plurality of second type sub-images, the first type sub-images and the second type sub-images have one-to-one correspondence, and a corresponding one of the second type sub-images is on a back of each of the first type sub-images, and when the switching module flips all the first type sub-images to the maximum angle to display the second operation screen of the second state of the electronic device, the switching module flips the first type sub-images to the backs to display the corresponding second type sub-images.

15. The control device according to claim 8, wherein when the electronic device is in the first state, the first operation screen completely covers the second operation screen, and when the switching module flips all the first type sub-images to the maximum angle to display the second operation screen of the second state of the electronic device, the switching module allows the first type sub-images to disappear when the first type sub-images are flipped to the maximum angle to display the second operation screen.
